(19) United States
(12) Patent Application Publication
(10) Pub. No.: US 2020/0364443 A1
(43) Pub. Date: Nov. 19, 2020

(54) METHOD FOR ACQUIRING MOTION TRACK AND DEVICE THEREOF, STORAGE MEDIUM, AND TERMINAL

(71) Applicant: Tencent Technology (Shenzhen) Company Limited, Shenzhen (CN)

(72) Inventors: Zhibo CHEN, Shenzhen (CN); Nan JIANG, Shenzhen (CN); Kaihong SHI, Shenzhen (CN); Xiaoming HUANG, Shenzhen (CN)

(21) Appl. No.: 16/983,848

(22) Filed: Aug. 3, 2020

Related U.S. Application Data
(63) Continuation of application No. PCT/CN2019/082646, filed on Apr. 15, 2019.

(30) Foreign Application Priority Data
May 15, 2018 (CN) 201810461812.4

(51) Int. Cl. G06K 9/00; G06T 7/246

(52) U.S. Cl. CPC G06K 9/00261; G06T 7/246; G06K 9/00288

(57) ABSTRACT

Embodiments of this application disclose a method and computing device for obtaining a moving track, a storage medium, and a terminal. The method includes the following operations: obtaining multiple sets of target images generated by multiple cameras for a photographed area, each set captured at a target moment within a selected time period; performing image recognition on each set of target images to obtain a set of face images of multiple target persons; respectively recording current position information of each face image corresponding to each person on a corresponding set of target images at a target moment; and outputting a set of moving tracks of the set of face images within the selected time period in chronological order, each moving track according to the current position information of a face image corresponding to a respective one of the multiple target persons within the multiple sets of target images.

### CROSS REFERENCE TO RELATED APPLICATIONS

This application is a continuation application of PCT Patent Application No. PCT/CN2019/082646, entitled “METHOD FOR ACQUIRING MOTION TRACK AND DEVICE THEREOF, STORAGE MEDIUM, AND TERMINAL” filed on Apr. 15, 2019, which claims priority to Chinese Patent Application No. 201810461812.4, entitled “METHOD AND DEVICE FOR OBTAINING MOVING TRACK, STORAGE MEDIUM, AND TERMINAL” filed on May 15, 2018, all of which are incorporated by reference in their entirety.

### FIELD OF THE TECHNOLOGY

This application relates to the field of computer technologies, and in particular, to a method and device for obtaining a moving track, a storage medium, and a terminal.

### BACKGROUND OF THE DISCLOSURE

With the development of security monitoring system and the trend of digitalized, networked, and intelligent monitoring, a video monitoring management platform has attracted more and more attention and has been gradually applied in an important security business system with a large number of front-end cameras, a complex business structure, and high management and integration.

### SUMMARY

Embodiments of this application provide a method for obtaining a moving track, performed by a computing device, including:

obtaining multiple sets of target images generated by multiple cameras for a photographed area, each set of target images being captured at a respective target moment within a selected time period;

performing image recognition on each of the multiple sets of target images to obtain a set of face images of multiple target persons in the set of target images;

respectively recording current position information of each face image corresponding to each of the multiple target persons in the set of face images on a corresponding set of target images at a corresponding target moment; and outputting a set of moving tracks of the set of face images within the selected time period in chronological order, each moving track according to the current position information of a face image corresponding to a respective one of the multiple target persons within the multiple sets of target images.

An embodiment of this application provides a non-transitory computer-readable storage medium storing a plurality of computer-executable instructions, the instructions, when executed by a processor of a computing device, cause the computing device to perform the foregoing operations of the method.

An embodiment of this application provides a computing device, comprising: a processor and a memory; the memory storing a plurality of computer programs, the computer programs being adapted to be executed by the processor to perform the foregoing operations of the method.

### BRIEF DESCRIPTION OF THE DRAWINGS

To describe the technical solutions in the embodiments of this application or in the related art more clearly, the following briefly introduces the accompanying drawings for describing the embodiments or the prior art. Apparently, the accompanying drawings in the following description show merely some embodiments of this application, and a person of ordinary skill in the art may still derive other drawings from the accompanying drawings without creative efforts.

FIG. 1A is a schematic diagram of a network structure applicable to a method for obtaining a moving track according to an embodiment of this application.

FIG. 1B is a schematic flowchart of a method for obtaining a moving track according to an embodiment of this application.

FIG. 2 is a schematic flowchart of a method for obtaining a moving track according to an embodiment of this application.

FIG. 3 is a schematic flowchart of a method for obtaining a moving track according to an embodiment of this application.

FIG. 4A and FIG. 4B are schematic diagrams of examples of a first source image and a second source image according to an embodiment of this application.

FIG. 5 is a schematic flowchart of a method for obtaining a moving track according to an embodiment of this application.

FIG. 6 is a schematic diagram of an example of face feature points according to an embodiment of this application.

FIG. 7 is a schematic diagram of an example of a fused target image according to an embodiment of this application.

FIG. 8 is a schematic flowchart of a method for obtaining a moving track according to an embodiment of this application.

FIG. 9A and FIG. 9B are schematic diagrams of examples of face image marks according to an embodiment of this application.

FIG. 10 is a schematic flowchart of a method for obtaining a moving track according to an embodiment of this application.

FIG. 11 is an example embodiment in an actual application scenario according to an embodiment of this application.

FIG. 12 is a schematic structural diagram of a device for obtaining a moving track according to an embodiment of this application.

FIG. 13 is a schematic structural diagram of a device for obtaining a moving track according to an embodiment of this application.

FIG. 14 is a schematic structural diagram of an image obtaining unit according to an embodiment of this application.

FIG. 15 is a schematic structural diagram of a face obtaining unit according to an embodiment of this application.

FIG. 16 is a schematic structural diagram of a position recording unit according to an embodiment of this application.

FIG. 17 is a schematic structural diagram of a terminal according to an embodiment of this application.

### DESCRIPTION OF EMBODIMENTS

The following clearly and completely describes the technical solutions in the embodiments of the present application with reference to the accompanying drawings in the embodiments of the present application. Apparently, the described embodiments are some of the embodiments of the present application rather than all of the embodiments. All other embodiments obtained by a person of ordinary skill in the art based on the embodiments of the present application without creative efforts shall fall within the protection scope of the present application.

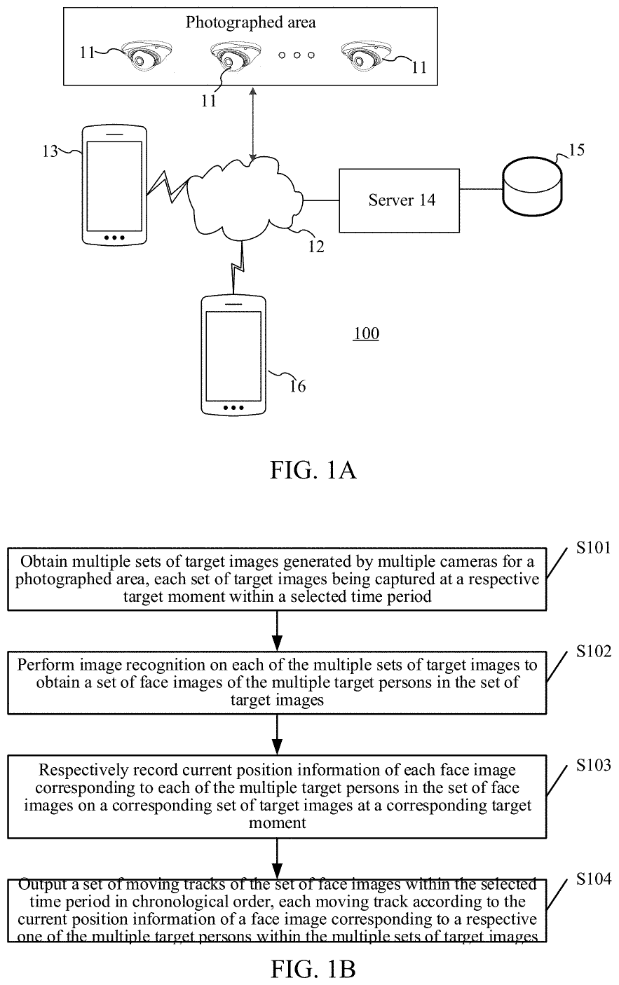

With reference to FIG. 1A to FIG. 10, a method for obtaining a moving track provided in the embodiments of this application is described in detail below.

FIG. 1A is a schematic diagram of a network structure applicable to a method for obtaining a moving track according to some embodiments of this application. As shown in FIG. 1A, a network 100 includes at least: an image collection device 11, a network 12, a first terminal device 13, and a server 14.

In some embodiments of this application, the foregoing image collection device 11 may be a camera, which may be located on a mobile track acquisition device, or may be used as an independent camera such as a camera installed in a public place such as a shopping mall or a station for video collection.

The network 12 may include a wired network and a wireless network. As shown in FIG. 1A, on an access network side, the image collection device 11 and the first terminal device 13 may be connected to the network 12 in a wireless manner or a wired manner. On a core network side, the server 14 is generally connected to the network 12 in a wired manner. Definitely, the server 14 may also be connected to the network 12 in a wireless manner.

The first terminal device 13, which may also be referred to as a mobile track obtaining device, may be a terminal device used by a manager of an agency such as a shopping mall, a scenic spot, a station, or a public security bureau, configured to perform the method for obtaining a moving track provided in this application, and may include a terminal device with computing and processing functions such as a tablet computer, a personal computer (PC), a smart phone, a palm computer, a mobile Internet device (MID), and the like.

The server 14 is configured to acquire data about a face and personal information of a user corresponding to the face from a face database 15 connected to the server. The server 14 may be an independent server, or may be a server cluster composed of a plurality of servers.

Further, the network 100 may further include a second terminal device 16. When it is determined that a first pedestrian has a fellow relationship with a second pedestrian, and the second pedestrian is illegal or has limited authority, relevant prompt information needs to be outputted to the second terminal device 16 of the first pedestrian.

FIG. 1B is a schematic flowchart of a method for obtaining a moving track according to an embodiment of this application. As shown in FIG. 1B, the method in the embodiment of this application may be performed by a first terminal device, including step S101 to step S104 below.

S101: Obtain multiple sets of target images generated by multiple cameras for a photographed area, each set of target images being captured at a respective target moment within a selected time period.

It may be understood that the selected time period may be any time period selected by a user, which may be a current time period, or may be a historical time period. Any moment within the selected time period is a target moment.

There is at least one camera in the photographed area, and when a plurality of cameras exist, fields of view among the plurality of cameras overlap. The photographed area may be a monitoring area such as a bank, a shopping mall, an independent store, and the like. The camera may be a fixed camera or a rotatable camera.

In specific implementation, when there is only one camera in the photographed area, video streams are collected through the camera, and a video stream corresponding to the selected time period is extracted from the collected video streams. A video frame in the video stream corresponding to the target moment is a target image. When there are a plurality of cameras in the photographed area, such as a first camera and a second camera, the device for obtaining a moving track obtains a first video stream collected by the first camera for the photographed area in a selected time period, extracts a first video frame (a first source image) corresponding to the target moment in the first video stream, obtains a second video stream collected by the second camera for the same photographed area in the selected time period, extracts a second video frame (a second source image) corresponding to the target moment in the second video stream, and then performs fusion processing on the first source image and the second source image to generate the target image. The fusion processing may be an image fusion technology based on scale invariant feature transform (SIFT) features, or may be an image fusion technology based on speeded up robust features (SURF), and may further be an image fusion technology based on oriented fast and rotated BRIEF (ORB). The SIFT feature is a local feature of an image, has good invariance to translation, rotation, scale scaling, brightness change, occlusion and noise, and maintains a certain degree of stability for visual change and affine transformation. The bottleneck of time complexity in the SIFT algorithm lies in establishment and matching of a descriptor. How to optimize the description method of feature points is the key to improve SIFT efficiency. The SURF algorithm has an advantage of a faster speed than the SIFT, and has good stability. In terms of time, the running speed of SURF is about 3 times of SIFT. In terms of quality, SURF has good robustness and higher recognition rate of feature points than SIFT. SURF is generally superior to SIFT in terms of viewing angle, illumination, and scale changes. The ORB algorithm is divided into two parts, respectively feature point extraction and feature point description. Feature extraction is developed by features from an accelerated segment test (FAST) algorithm, and feature point description is improved according to a binary independent elementary features (BRIEF) feature description algorithm. The ORB algorithm combines the detection method of FAST feature points with the BRIEF feature descriptor, and makes improvement and optimization on the original basis. In the embodiment of this application, the ORB image fusion technology is preferentially adopted, and the ORB is short for oriented BRIEF and is an improved version of the BRIEF algorithm. The ORB algorithm is 100 times faster than the SIFT algorithm and 10 times faster than the SURF algorithm. The ORB algorithm may quickly and effectively fuse images of a plurality of cameras, reduce the number of processed image frames, and improve efficiency.

The device for obtaining a moving track may include a terminal device with computing and processing functions such as a tablet computer, a personal computer (PC), a smart phone, a palmtop computer, and a mobile Internet device (MID).

The target image may include a face area and a background area, and the device for obtaining a moving track may filter out the background area in the target image to obtain a face image including the face area. Definitely, the device for obtaining a moving track may not need to filter out the background area.

S102: Perform image recognition on each of the multiple sets of target images to obtain a set of face images of the multiple target persons in the set of target images.

It may be understood that the image recognition processing may be detecting the face area of the target image, and when the face area is detected, the face image of the target image may be marked, which may be specifically performed according to actual scenario requirements. The face detection process may adopt a face recognition method based on principal component analysis (PCA), a face recognition method based on elastic graph matching, a face recognition method based on a support vector machine (SVM), and a face recognition method based on a deep neural network.

The face recognition method based on PCA is also a face recognition method based on KL transform, KL transform being optimal orthogonal transform for image compression. After a high-dimensional image space undergoes KL transform, a new set of orthogonal bases is obtained. An important orthogonal basis thereof is retained, and these orthogonal bases may be expanded into a low-dimensional linear space. If projections of faces in these low-dimensional linear spaces are assumed to be separable, these projections may be used as feature vectors for recognition, which is a basic idea of the feature face method. However, this method requires more training samples and takes a very long time, and is completely based on statistical characteristics of image gray scale.

The face recognition method based on elastic graph matching is to define a certain invariable distance for normal face deformation in two-dimensional space, and use an attribute topology graph to represent the face. Any vertex of the topology graph includes a feature vector to record information about the face near the vertex position. The method combines gray scale characteristics and geometric factors, allows the image to have elastic deformation during comparison, and has achieved a good effect in overcoming the influence of expression changes on recognition. In addition, a plurality of samples are not needed for training for a single person, but repeated calculation is very computationally intensive.

According to the face recognition method based on SVM, a learning machine is made to achieve a compromise in experience risk and generalization ability, thereby improving the performance of the learning machine. The support vector machine mainly resolves a two-class problem, and its basic idea is to try to transform a low-dimensional linearly inseparable problem into a high-dimensional linearly separable problem. General experimental results show that SVM has a good recognition rate, but requires a large number of training samples (300 in each class), which is often unrealistic in practical application. Moreover, the support vector machine takes a long time for training and has a complicated method for implementation. There is no unified theory on the method of selecting this function.

Therefore, in the embodiment of this application, high-level abstract features may be used for face recognition, so that face recognition is more effective, and the accuracy of face recognition is greatly improved by combining a recurrent neural network.

In specific implementation, the device for obtaining a moving track may perform image recognition processing on the target image, to obtain face feature points corresponding to the target image, and intercept or mark the face image in the target image based on the face feature points. The device for obtaining a moving track may recognize and locate the face and facial features of the user in the photo by using a face detection technology (for example, a face detection technology provided by a cross-platform computer vision library OpenCV, a new vision service platform Face++, YouTu face detection, and the like). The facial feature points may be reference points indicating facial features, for example, a facial contour, an eye contour, a nose, a lip, and the like, which may be 83 reference points or 68 reference points, and a specific number of points may be determined by developers according to requirements.

The target image includes a set of face images, which may include 0, 1, or a plurality of face images.

S103: Respectively record current position information of each face image corresponding to each of the multiple target persons in the set of face images on a corresponding set of target images at a corresponding target moment.

It may be understood that the current position information may be coordinate information, which is two-dimensional coordinates or three-dimensional coordinates. Each face image in the set of face images respectively corresponds to a piece of current position information at the target moment.

In specific implementation, for the target face image (any face image) in the set of face images, the device for obtaining a moving track records the current position information of the target face image on the target image at the target moment, and records the current position information of other face images in the set of face images in the same manner.

For example, if the set of face images include three face images, a coordinate 1, a coordinate 2, and a coordinate 3 of the three face images on the target image at the target moment are recorded respectively.

S104: Output a set of moving tracks of the set of face images within the selected time period in chronological order, each moving track according to the current position information of a face image corresponding to a respective one of the multiple target persons within the multiple sets of target images.

It may be understood that the chronological order refers to chronological order of the selected time period.

In specific implementation, after the set of face images at the target moment is compared with the set of face images at a previous moment, coordinate information of the same face image at the two moments is outputted in sequence to form a face movement track of the same face image. However, for different face images (new face images), current position information of the new face image is recorded, and the new face image may be added to the set of face images. Then at the next moment of the target moment, through the comparison of the set of face images, the face movement track of the new face may be constructed, and a set of face movement tracks of all face images in the selected time period in the set of face images may be outputted in the same manner. The new face image is added to the set of face images, which may implement real-time update of the set of face images.

For example, for the target image in the set of face images, at a target moment 1 of the selected time period, a coordinate of the target face image on the target image is a coordinate A1, at a target moment 2 of the selected time period, the coordinate of the target face image on the target image is a coordinate A2, and at a target moment 3 of the selected time period, a coordinate of the target face image on the target image is a coordinate A3. Then A1, A2, A3 are displayed in sequence in chronological order, and preferably, A1, A2, and A3 are mapped into specific face movement tracks through video frames. For the method for outputting the moving track of other face images, reference may be made to the output process of the moving track of the target face image, and details are not described herein, thereby forming a set of moving tracks.

In some embodiments, after obtaining the set of moving tracks of the face, the moving tracks of each face in the set of moving tracks may be compared in pairs to determine the same moving track thereof. Preferably, pedestrian information indicated by the same moving track may be analyzed, and when it is determined, based on the analysis result, that an abnormal condition exists, an alarm prompt is transmitted to the corresponding pedestrian to prevent property loss or avoid potential safety hazards.

The solution is mainly applied to scenarios with high safety level or ultra-large-scale monitoring, for example, banks, national defense agencies, airports, and stations with high safety factor requirements and high traffic density. There are three aspects in the implementation. A plurality of high-definition cameras or ordinary surveillance cameras are used as front-end hardware. The cameras may be installed in various corners of various scenarios. Various expansion functions are provided by major product manufacturers. Considering the image fusion process, the same model of cameras is the best. The backend is controlled by using Tencent Youtu software service, and the hardware carrier is provided by other hardware service manufacturers. The display terminal adopts a super-large screen or multi-screen display.

In the embodiment of the application, by recognizing the face image in the collected video and recording the position information of the face image appearing in the video at different moments to restore the face movement track, the user is monitored based on the face movement track, avoiding variability, diversity, and instability of the human body behavior, thereby reducing the calculation amount of the user monitoring behavior. In addition, the behavior of determining a pedestrian in the monitoring scenario based on the analysis of the face movement track enriches the monitoring calculation method, and provides strong support for security in various scenarios.

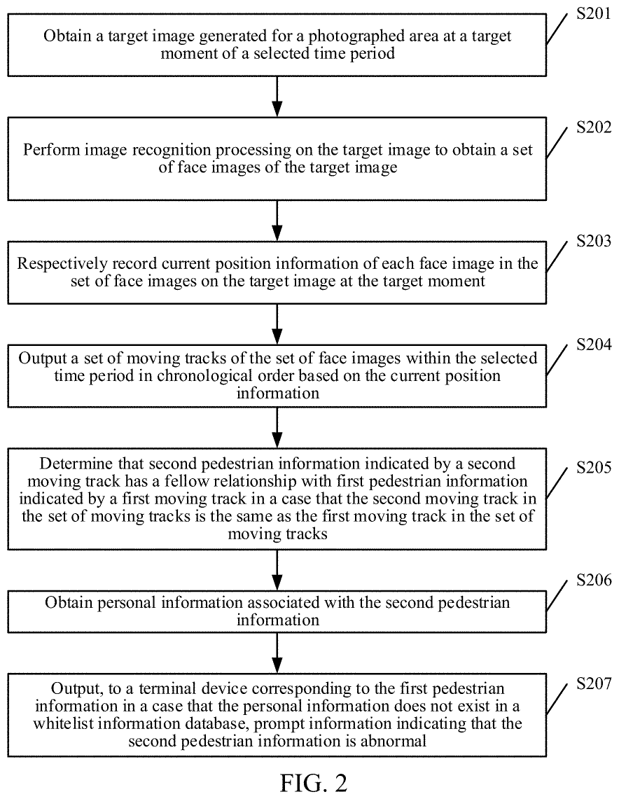

FIG. 2 is a schematic flowchart of another method for obtaining a moving track according to an embodiment of this application. As shown in FIG. 2, the method in this embodiment of this application may include step S201 to step S207 below.

S201: Obtain a target image generated for a photographed area at a target moment of a selected time period.

It may be understood that the selected time period may be any time period selected by a user, which may be a current time period, or may be a historical time period. Any moment within the selected time period is a target moment.

There is at least one camera in the photographed area, and when a plurality of cameras exist, fields of view among the plurality of cameras overlap. The photographed area may be a monitoring area such as a bank, a shopping mall, an independent store, and the like. The camera may be a fixed camera or a rotatable camera.

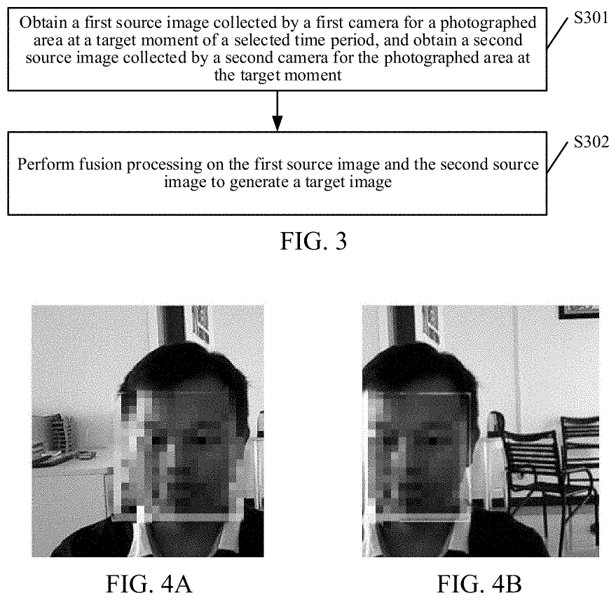

In a feasible implementation, as shown in FIG. 3, the obtaining multiple sets of target images generated by multiple cameras for a photographed area, each set of target images being captured at a respective target moment within a selected time period includes the following steps.

S301: Obtain a first source image collected by a first camera for a photographed area at a target moment of a selected time period, and obtain a second source image collected by a second camera for the photographed area at the target moment.

It may be understood that the fields of view of the first camera and the second camera overlap, that is, there are the same pixel points in the images collected by the two cameras. More same pixel points lead to a larger overlapping area of the field of view. For example, FIG. 4A shows the first source image collected by the first camera, and FIG. 4B shows the second source image collected by the second camera with the field of view overlapping that of the first camera, then the first source image and the second source image have an area that is partially the same.

Each camera collects a video stream in a selected time period, and the video stream includes a multi-frame video, that is, a multi-frame image, and a per-frame image is in a one-to-one correspondence with time.

In specific implementation, the first video stream corresponding to the selected time period is intercepted from the video stream collected by the first camera, and then the video frame corresponding to the target moment, that is, the first source image, is found in the first video stream. In addition, the second source image corresponding to the second camera at the target moment is found in the same manner.

S302: Perform fusion processing on the first source image and the second source image to generate a target image.

It may be understood that the fusion processing may be an image fusion technology based on SIFT features, or may be an image fusion technology based on SURF features, and may further be an image fusion technology based on ORB features. The SIFT feature is a local feature of an image, has good invariance to translation, rotation, scale scaling, brightness change, occlusion and noise, and maintains a certain degree of stability for visual change and affine transformation. The bottleneck of time complexity in the SIFT algorithm lies in establishment and matching of a descriptor. How to optimize the description method of feature points is the key to improve SIFT efficiency. The SURF algorithm has an advantage of a faster speed than the SIFT, and has good stability. In terms of time, the running speed of SURF is about 3 times of SIFT. In terms of quality, SURF has good robustness and higher recognition rate of feature points than SIFT. SURF is generally superior to SIFT in terms of viewing angle, illumination, and scale changes. The ORB algorithm is divided into two parts, respectively feature point extraction and feature point description. Feature extraction is developed by features from a FAST algorithm, and feature point description is improved according to a BRIEF feature description algorithm. The ORB feature combines the detection method of FAST feature points with the BRIEF feature descriptor, and makes improvement and optimization on the original basis. In the embodiment of this application, the image fusion technology of the ORB feature is preferentially adopted. The ORB algorithm is 100 times faster than the SIFT algorithm and 10 times faster than the SURF algorithm. The ORB algorithm may quickly and effectively fuse images of a plurality of cameras, reduce the number of processed image frames, and improve efficiency. The image fusion technology mainly includes the process of feature extraction, image registration, and image splicing.

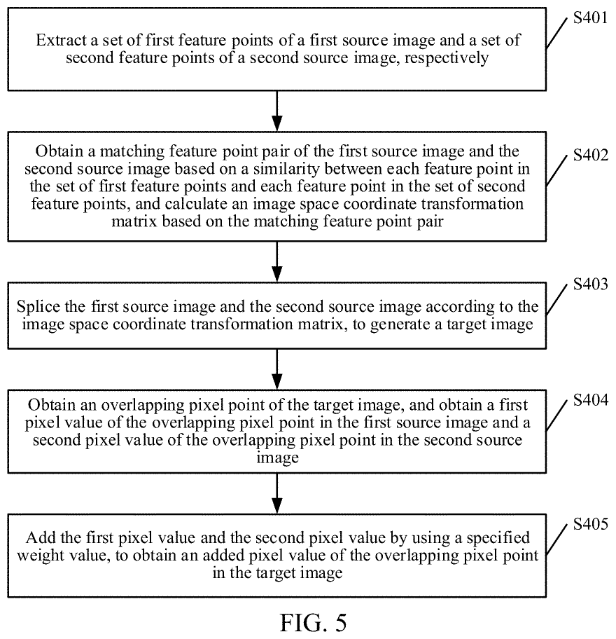

In a specific implementation, as shown in FIG. 5, the performing fusion processing on the first source image and the second source image to generate the target image includes the following steps.

S401: Extract a set of first feature points of the first source image and a set of second feature points of the second source image, respectively.

It may be understood that the feature points of the image may be simply understood as relatively significant points in the image, such as contour points, bright points in darker areas, dark points in lighter areas, and the like. The feature points in the set of feature points may include boundary feature points, contour feature points, straight line feature points, corner point feature points, and the like. However, the ORB uses the FAST algorithm to detect feature points, that is, based on the image gray values around the feature points, detects the pixel values around the candidate feature points. If there are enough pixel points in the area around the candidate point, which have gray values different from that of the candidate point, the candidate point is considered as a feature point.

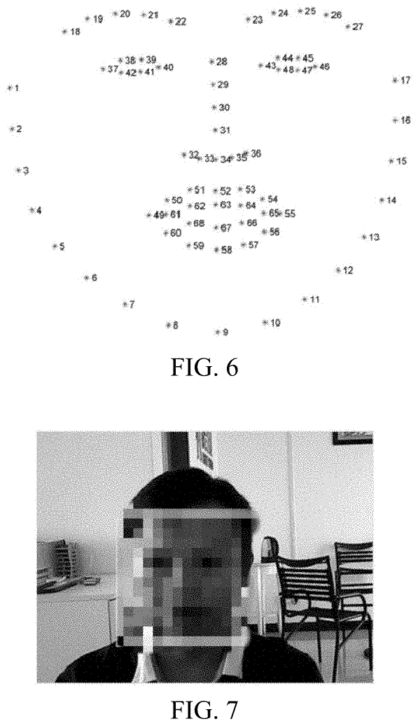

The rest of the feature points on the target image may be obtained by rotating a scanning line. For the method for obtaining the rest of the feature points, reference may be made to the process of acquiring the first feature point, and details are not described herein. It may be understood that the device for obtaining a movement track may obtain a target number of feature points, and the target data may be specifically set according to empirical values. For example, as shown in FIG. 6, 68 feature points on the target image may be obtained. The feature points are reference points indicating facial features, such as a facial contour, an eye contour, a nose, a lip, and the like.

S402: Obtain a matching feature point pair of the first source image and the second source image based on a similarity between each feature point in the set of first feature points and each feature point in the set of second feature points, and calculate an image space coordinate transformation matrix based on the matching feature point pair.

It may be understood that the registration process for the two images is to find the matching feature point pair in the set of feature points of the two images through similarity measurement, and then calculate the image space coordinate transformation matrix through the matching feature point pair. In other words, the image registration process is a process of calculating an image space coordinate transformation matrix.

The image registration method may include relative registration and absolute registration. Relative registration is selecting one of a plurality of images as a reference image and registering other related images with the image, which has an arbitrary coordinate system. Absolute registration means defining a control grid first, all images being registered relative to the grid, that is, geometric correction of each component image is completed separately to realize the unification of coordinate systems.

Either one of the first source image and the second source image may be selected as a reference image, or a designated reference image may be used as a reference image, and the image space coordinate transformation matrix is calculated by using a gray information method, a transformation domain method, or a feature method.

S403: Splice the first source image and the second source image according to the image space coordinate transformation matrix, to generate the target image.

In specific implementation, the method for splicing the two images may be to copy one image to another image according to the image space coordinate transformation matrix, or to copy the two images to the reference image according to the image space coordinate transformation matrix, thereby implementing the splicing process of the first source image and the second source image, and using the spliced image as the target image.

For example, after the first source image corresponding to FIG. 4A and the second source image corresponding to FIG. 4B are spliced according to the calculated coordinate transformation matrix, the target image shown in FIG. 7 may be obtained.

S404: Obtain an overlapping pixel point of the target image, and obtain a first pixel value of the overlapping pixel point in the first source image and a second pixel value of the overlapping pixel point in the second source image.

It may be understood that after the first source image and the second source image are spliced, the transition at the junction of the two images will not be smooth due to the light color. Therefore, the pixel values of overlapping pixel points need to be recalculated. That is, the pixel values of overlapping pixel points in the first source image and the second source image need to be obtained respectively.

S405: Add the first pixel value and the second pixel value by using a specified weight value, to obtain an added pixel value of the overlapping pixel point in the target image.

It may be understood that the previous image is slowly transitioned to the second image through weighted fusion, that is, the pixel values of the overlapping areas of the images are added according to a certain weight value.

In other words, a pixel value of an overlapping pixel point 1 in the first source image is S11, and a pixel value in the second source image is S21. Then, after weighted calculation based on u times S1l and v times S21, a pixel value of the overlapping pixel point 1 in the target image is uS11+Vs21.

S202: Perform image recognition processing on the target image to obtain a set of face images of the target image.

It may be understood that the image recognition processing may be detecting the face area of the target image, and when the face area is detected, the face image of the target image may be marked, which may be specifically performed according to actual scenario requirements.

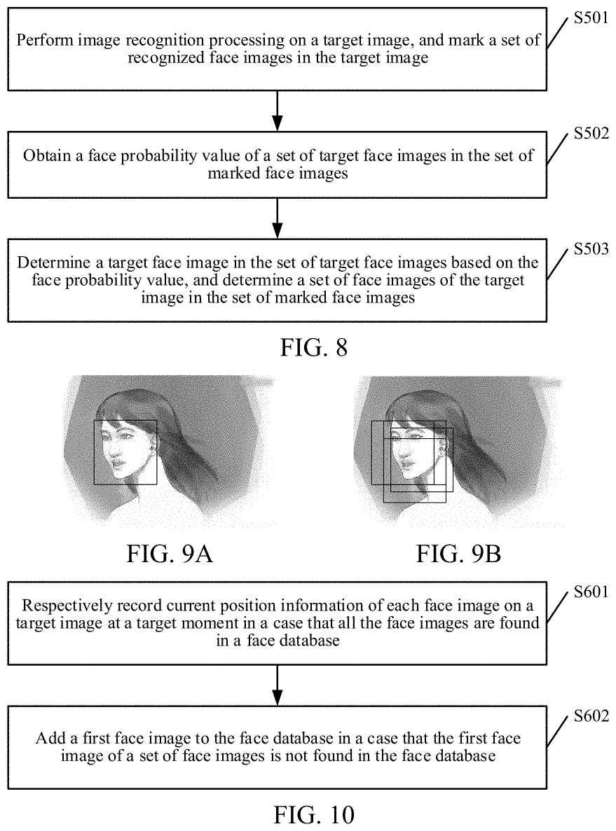

In a feasible implementation, as shown in FIG. 8, the performing image recognition on each of the multiple sets of target images to obtain a set of face images of the multiple target persons in the set of target images includes the following steps.

S501: Perform image recognition on one of the multiple sets of target images, and marking a set of recognized face images in the set of target images.

It may be understood that, the image recognition algorithm is a face recognition algorithm. The face recognition algorithm may use a face recognition method based on PCA, a face recognition method based on elastic graph matching, a face recognition method based on an SVM, and a face recognition method based on a deep neural network.

The face recognition method based on PCA is also a face recognition method based on KL transform, KL transform being optimal orthogonal transform for image compression. After a high-dimensional image space undergoes KL transform, a new set of orthogonal bases is obtained. An important orthogonal basis thereof is retained, and these orthogonal bases may be expanded into a low-dimensional linear space. If projections of faces in these low-dimensional linear spaces are assumed to be separable, these projections may be used as feature vectors for recognition, which is a basic idea of the feature face method. However, this method requires more training samples and takes a very long time, and is completely based on statistical characteristics of image gray scale.

The face recognition method based on elastic graph matching is to define a certain invariable distance for normal face deformation in two-dimensional space, and use an attribute topology graph to represent the face. Any vertex of the topology graph includes a feature vector to record information about the face near the vertex position. The method combines gray scale characteristics and geometric factors, allows the image to have elastic deformation during comparison, and has achieved a good effect in overcoming the influence of expression changes on recognition. In addition, a plurality of samples are not needed for training for a single person, but repeated calculation is very computationally intensive.

According to the face recognition method based on SVM, a learning machine is made to achieve a compromise in experience risk and generalization ability, thereby improving the performance of the learning machine. The support vector machine mainly resolves a two-class problem, and its basic idea is to try to transform a low-dimensional linearly inseparable problem into a high-dimensional linearly separable problem. General experimental results show that SVM has a good recognition rate, but requires a large number of training samples (300 in each class), which is often unrealistic in practical application. Moreover, the support vector machine takes a long time for training and has a complicated method for implementation. There is no unified theory on the method of selecting this function.

Therefore, in the embodiment of this application, high-level abstract features may be used for face recognition, so that face recognition is more effective, and the accuracy of face recognition is greatly improved by combining a recurrent neural network.

A deep neural network is a CNN. In the CNN, neurons of the convolution layer are only connected to some neuron nodes of the previous layer, that is, the connections between neurons thereof are not fully connected, and a weight ww and an offset bb of the connection between some nerves in the same layer are shared (that is, the same), which greatly reduces the number of required training parameters. A structure of the convolutional neural network CNN generally includes a multi-layer structure: an input layer configured to input data; a convolutional layer configured to extract and map features by using a convolution kernel; an excitation layer, since convolution is also a linear operation, nonlinear mapping needing to be increased; a pooling layer performing downsampling and performing thinning processing on a feature map, to reduce the amount of calculated data; a fully connected layer usually refitted at the end of the CNN to reduce the loss of feature information; and an output layer configured to output a result. Definitely, some other functional layers may also be used in the middle, for example, a normalization layer normalizing the features in the CNN; a segmentation layer learning some (picture) data separately by area; and a fusion layer fusing branches that independently perform feature learning.

That is, after the face is detected and the key feature points of the face are located, the main face area may be extracted and fed into the back-end recognition algorithm after preprocessing. The recognition algorithm is to be used for completing the extraction of face features and comparing a face with the known faces in stock, so as to determine a set of face images included in the target image. The neural network may have different depth values, such as a depth value of 1, 2, 3, 4, or the like, because features of CNNs of different depths represent different levels of abstract features. A deeper depth leads to a more abstract feature of the CNN, and the features of different depths may be used for describing the face more comprehensively, achieving a better effect of face detection.

The recognized face image is marked, it may be understood that a recognized result is marked with shapes such as rectangle, ellipse, or circle. For example, as shown in FIG. 9A, when a face image is recognized in the target image, the face image is marked by using a rectangular frame. Preferably, if there are a plurality of recognition results for the same object, each recognition result is respectively marked with a rectangular frame, as shown in FIG. 9B.

S502: Obtain a face probability value of a set of target face images in the set of marked face images.

It may be understood that, in the set of face images, there are a plurality of recognition results for the target face image, and each recognition result corresponds to a face probability value, the face probability value being a score of a classifier.

For example, if there are 5 face images in the set of face images, one of the face images is selected as the target image. If there are 3 recognition results for the target image, there are corresponding 3 face probability values.

S503: Determine a target face image in the set of target face images based on the face probability value, and determine a set of face images of the target image in the set of marked face images.

It may be understood that since there are a plurality of recognition results for the same target face image, and the plurality of recognition results overlap, it is also necessary to perform non-maximum suppression on marked face frames to delete the face frame with a relatively large degree of overlapping.

The non-maximum suppression is to suppress elements that are not maxima, and search for the local maxima. This local part represents a neighborhood. The neighborhood has two variable parameters, one is a dimension of the neighborhood, and the other is a size of the neighborhood. For example, in pedestrian detection, each sliding window will get a score after feature extraction and classification and recognition by the classifier. However, the sliding windows will cause many windows to contain or mostly intersect with other windows. In this case, non-maximum suppression is needed to select the windows with the highest scores (that is, the highest probability of face images) in the neighborhood, and suppress the windows with low scores.

For example, assuming that six rectangular frames are recognized and marked for the same target face image, sorting is performed according to the classification probability of the classifier category, and the probabilities of belonging to faces in ascending order are A, B, C, D, E, and F, respectively. From the maximum probability rectangular frame F, it is respectively determined whether the degree of overlapping IOU of A to E and F is greater than a certain specified threshold value. Assuming that the degree of overlapping of B, D, and F exceeds the threshold value, then B and D are discarded, and the first rectangular frame F is retained. From the remaining rectangular frames A, C, and E, E with the largest probability is selected, and then the overlapping degree between E and A and C is determined. If the overlapping degree is greater than a certain threshold, then A and C are discarded, and the second rectangular frame E is retained, and so on, thereby finding the optimal rectangular frame.

In specific implementation, the probability values of a plurality of faces of the same target face are sorted, the target face images with lower scores are suppressed through a non-maximum suppression algorithm to determine the optimal face images, and each target face image in the set of face images is recognized in turn in the same manner, thereby finding a set of optimal face images in the target image.

S203: Respectively record current position information of each face image in the set of face images on the target image at the target moment.

The current position information may be coordinate information, which is two-dimensional coordinates or three-dimensional coordinates. Each face image in the set of face images respectively corresponds to a piece of current position information at the target moment.

In a feasible implementation, as shown in FIG. 10, the respectively recording current position information of each face image in the set of face images on the target image at the target moment includes the following steps.

S601: Respectively record current position information of each face image on a target image at a target moment in a case that all the face images are found in a face database.

In specific implementation, the set of recognized face images are compared with the face database to determine whether the set of face images all exist in the face database. If yes, it indicates that set of these face images have been recognized at a previous moment of the target moment, and in this case, the current position information of each face image on the target image at the target moment is recorded.

The face database is a face information database for collection and storage in advance, and may include relevant data of a face and personal information of a user corresponding to the face. Preferably, the face database is obtained through pulling toward the server by the device for obtaining a moving track.

For example, if the face images A, B, C, D, and E in the set of face images all exist in the face database, coordinates of A, B, C, D, and E on the target image at the target moment are recorded respectively.

S602: Add a first face image to the face database in a case that the first face image of the set of face images is not found in the face database.

In specific implementation, the set of recognized face images are compared with the face database to determine whether the set of face images all exist in the face database. If some or all of the images do not exist in the face database, it indicates that the set of these face images are not recognized at the previous moment of the target moment. In this case, the current position information of each face image on the target image at the target moment is recorded, and the position information and the face image are added to the face database. On the one hand, the real-time update of the face database may be realized, and on the other hand, all the recognized face images and the corresponding position information may be completely recorded.

For example, A in the face images A, B, C, D, and E in the set of face images does not exist in the face database, the coordinates of A, B, C, D, and E on the target image at the target moment are recorded respectively, and the image information of A and the corresponding position information are added to the face database for comparison of A at the next moment of the target moment.

S204: Output a set of moving tracks of the set of face images within the selected time period in chronological order based on the current position information.

In specific implementation, after the set of face images at the target moment is compared with the set of face images at a previous moment, coordinate information of the same face image at the two moments is outputted in sequence to form a face movement track of the same face image. However, for different face images (new face images), current position information of the new face image is recorded, and the new face image may be added to the set of face images. Then at the next moment of the target moment, through the comparison of the set of face images, the face movement track of the new face may be constructed, and a set of face movement tracks of all face images in the selected time period in the set of face images may be outputted in the same manner. The new face image is added to the set of face images, which may implement real-time update of the set of face images.

For example, for the target image in the set of face images, at a target moment 1 of the selected time period, a coordinate of the target face image on the target image is a coordinate A1, at a target moment 2 of the selected time period, the coordinate of the target face image on the target image is a coordinate A2, and at a target moment 3 of the selected time period, a coordinate of the target face image on the target image is a coordinate A3. Then A1, A2, A3 are displayed in sequence in chronological order, and preferably, A1, A2, and A3 are mapped into specific face movement tracks through video frames. For the method for outputting the moving track of other face images, reference may be made to the output process of the moving track of the target face image, and details are not described herein, thereby forming a set of moving tracks. The track analysis based on the face is creatively realized by using the face movement track, instead of the analysis based on a human body shape, thereby avoiding the variability and instability of the appearance of the human body shape.

S205: Determine that second pedestrian information indicated by a second moving track has a fellow relationship with first pedestrian information indicated by a first moving track in a case that the second moving track in the set of moving tracks is the same as the first moving track in the set of moving tracks. In some embodiments, the computing device selects, among the set of moving tracks, a first moving track and a second moving track that is substantially the same as the first moving track; obtains personal information of a first target person corresponding to the first moving track and a second target person corresponding to the second moving track; and marks the personal information indicating that the first target person and the second target person are travel companions of each other.

It may be understood that by comparing the movement tracks corresponding to every two face images in the set of movement tracks, when an error of the two comparison results is within a certain threshold range, the two movement tracks may be considered to be the same, and then pedestrians corresponding to the two movement tracks may be determined as fellows.

Through the analysis of the set of face movement tracks, the potential “fellow” detection is provided, so that the monitoring level is improved from conventional monitoring for individuals to monitoring for groups.

S206: Obtain personal information associated with the second pedestrian information.

In a feasible implementation, when it is determined that the second pedestrian is a fellow of the first pedestrian, it is necessary to verify the legitimacy of the second pedestrian, and personal information of the second pedestrian needs to be obtained, for example, personal information of the second pedestrian is requested from the server based on the face image of the second pedestrian.

S207: Output, to a terminal device corresponding to the first pedestrian information in a case that the personal information does not exist in a whitelist information database, prompt information indicating that the second pedestrian information is abnormal. For example, the computing device sends, to the terminal device corresponding to the first target person in a case that the personal information of the second target person does not exist in a whitelist information database associated with the first target person.

It may be understood that the whitelist information database includes user information with legal rights, such as personal credit, access rights to information, no bad records, and the like.

In specific implementation, when the device for obtaining a moving track does not find the personal information of the second pedestrian in the whitelist information database, it is determined that the second pedestrian has abnormal behavior, and warning information is outputted to the first pedestrian for prompt, to prevent the loss of interest or safety from being generated. The warning information may be output in the form of text, audio, flashing lights, and the like. The specific method is not limited.

On the basis of analysis for the path and fellows, alarm analysis may be used for implementing multi-level and multi-scale alarm support according to different situations.

The solution is mainly applied to scenarios with high safety level or ultra-large-scale monitoring, for example, banks, national defense agencies, airports, and stations with high safety factor requirements and high traffic density. There are three aspects in the implementation. A plurality of high-definition cameras or ordinary surveillance cameras are used as front-end hardware. The cameras may be installed in various corners of various scenarios. Various expansion functions are provided by major product manufacturers. Considering the image fusion process, the same model of cameras is the best. The backend is controlled by using Tencent Youtu software service, and the hardware carrier is provided by other hardware service manufacturers. The display terminal adopts a super-large screen or multi-screen display.

In the embodiment of the application, by recognizing the face image in the collected video and recording the position information of the face image appearing in the video at different moments to restore the face movement track, the user is monitored based on the face movement track, avoiding variability, diversity, and instability of the human body behavior, thereby reducing the calculation amount of user monitoring behavior. In addition, the behavior of determining a pedestrian in the monitoring scenario based on the analysis of the face movement track enriches the monitoring calculation method, and behavior of pedestrians in the scene is monitored from point to surface, from individual to group, from monitoring to reminding, and through multi-scale analysis, which provides strong support for security in various scenarios. In addition, due to the end-to-end statistical architecture, it is very convenient in practical application and has a wider application range.

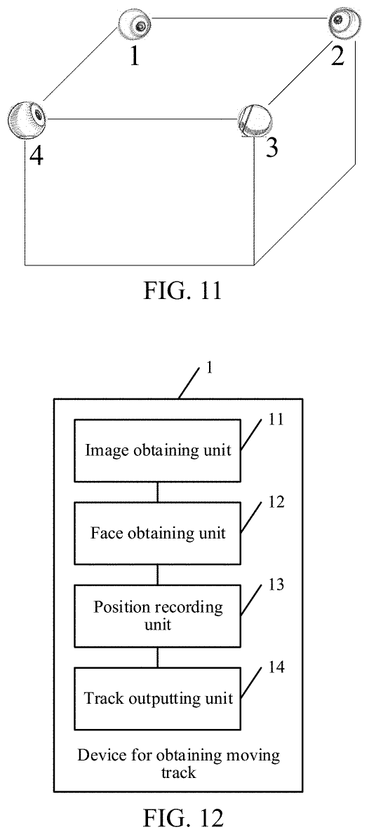

FIG. 11 is a schematic diagram of a scenario of a method for obtaining a moving track according to an embodiment of this application. As shown in FIG. 11, in the embodiment of this application, a method for obtaining a moving track is specifically described in a manner of an actual monitoring scenario.

Four cameras are installed in four corners of the monitoring room shown in FIG. 11, respectively No. 1, No. 2, No. 3, and No. 4. There is overlapping of some or all fields of view between these four cameras, and the camera may be located on the device for obtaining a moving track, or may also serve as an independent device for video collection.

The device for obtaining a moving track obtains the images collected for the four cameras at any moment in the selected time period, and then generates a target image after fusing the obtained four images through the methods such as image feature extraction, image registration, image splicing, image optimization, and the like.

Then, an image recognition algorithm such as a convolution neural network (CNN) is used for recognizing the set of face images in the target image, such as 0, 1, or a plurality of face images, and mark and display the recognized face images. However, if there are a plurality of recognition results for one image, an optimal recognition result of the plurality of marking results may be screened out according to the probability value of recognition and marking and the maximum suppression, and the set of recognized face images are processed respectively in this manner, thereby recognizing a set of optimal face images on the target image.

Position information such as the coordinate size, direction, and angle of each face image on the target image in the set of face images at this time is recorded, the position information of the face on each target image in the selected time period is recorded in the same manner, and the position of each face image is outputted in chronological order, thereby forming a set of face movement tracks.

In a case that the same moving track exists in the set of face tracks and respectively corresponds to a first pedestrian and a second pedestrian, it is determined that the first pedestrian has a fellow relationship with the second pedestrian. If the first pedestrian is a legal user, it is necessary to obtain personal information of the second pedestrian, and compare the personal information with the legal information in the whitelist information database to determine the legitimacy of the second pedestrian. In a case that it is determined that the second pedestrian is illegal or has limited authority, it is necessary to output relevant prompt information to the first pedestrian to avoid loss of property or safety.

The analysis of face movement tracks avoids the variability, diversity, and instability of human behavior, and does not involve image segmentation or classification, thereby reducing the calculation amount of user monitoring behavior. In addition, the behavior of determining a pedestrian in the monitoring scenario based on the analysis of the face movement track enriches the monitoring calculation method, and provides strong support for security in various scenarios.

With reference to FIG. 12 to FIG. 16, a device for obtaining a moving track provided in the embodiments of this application is described in detail below. The device shown in FIG. 12 to FIG. 16 is configured to perform the method of the embodiment shown in FIG. 1A to FIG. 11 in this application. For convenience of description, a part related to the embodiment of this application is only shown. For specific technical details that are not disclosed, reference may be made to the embodiments shown in FIG. 1A to FIG. 11 of this application.

FIG. 12 is a schematic structural diagram of a device for obtaining a moving track according to an embodiment of this application. As shown in FIG. 12, a device 1 for obtaining a moving track in the embodiment of this application may include: an image obtaining unit 11, a face obtaining unit 12, a position recording unit 13, and a track outputting unit 14.

The image obtaining unit 11 is configured to obtain multiple sets of target images generated by multiple cameras for a photographed area, each set of target images being captured at a respective target moment within a selected time period.

It may be understood that the selected time period may be any time period selected by a user, which may be a current time period, or may be a historical time period. Any moment within the selected time period is a target moment.

There is at least one camera in the photographed area, and when a plurality of cameras exist, fields of view among the plurality of cameras overlap. The photographed area may be a monitoring area such as a bank, a shopping mall, an independent store, and the like. The camera may be a fixed camera or a rotatable camera.

In specific implementation, when there is only one camera in the photographed area, video streams are collected through the image obtaining unit 11, and a video stream corresponding to the selected time period is extracted from the collected video streams. A video frame in the video stream corresponding to the target moment is a target image. When there are a plurality of cameras in the photographed area, such as a first camera and a second camera, the image obtaining unit 11 obtains a first video stream collected by the first camera for the photographed area in a selected time period, extracts a first video frame (a first source image) corresponding to the target moment in the first video stream, obtains a second video stream collected by the second camera for the same photographed area in the selected time period, extracts a second video frame (a second source image) corresponding to the target moment in the second video stream, and then performs fusion processing on the first source image and the second source image to generate the target image. The fusion processing may be an image fusion technology based on SIFT features, or may be an image fusion technology based on SURF features, and may further be an image fusion technology based on Oriented FAST and Rotated BRIEF (ORB) features. The SIFT feature is a local feature of an image, has good invariance to translation, rotation, scale scaling, brightness change, occlusion and noise, and maintains a certain degree of stability for visual change and affine transformation. The bottleneck of time complexity in the SIFT algorithm lies in establishment and matching of a descriptor. How to optimize the description method of feature points is the key to improve SIFT efficiency. The SURF algorithm has an advantage of a faster speed than the SIFT, and has good stability. In terms of time, the running speed of SURF is about 3 times of SIFT. In terms of quality, SURF has good robustness and higher recognition rate of feature points than SIFT. SURF is generally superior to SIFT in terms of viewing angle, illumination, and scale changes. The ORB algorithm is divided into two parts, respectively feature point extraction and feature point description. Feature extraction is developed by features from a FAST algorithm, and feature point description is improved according to a BRIEF feature description algorithm. The ORB feature combines the detection method of FAST feature points with the BRIEF feature descriptor, and makes improvement and optimization on the original basis. In the embodiment of this application, the ORB image fusion technology is preferentially adopted, and the ORB is short for oriented BRIEF and is an improved version of the BRIEF algorithm. The ORB algorithm is 100 times faster than the SIFT algorithm and 10 times faster than the SURF algorithm. The ORB algorithm may quickly and effectively fuse images of a plurality of cameras, reduce the number of processed image frames, and improve efficiency.

The target image may include a face area and a background area, and the image obtaining unit 11 may filter out the background area in the target image to obtain a face image including the face area. Definitely, the image obtaining unit 11 may not need to filter out the background area.

The face obtaining unit 12 is configured to perform image recognition on each of the multiple sets of target images to obtain a set of face images of multiple target persons in the set of target images.

It may be understood that the image recognition processing may be detecting the face area of the target image, and when the face area is detected, the face image of the target image may be marked, which may be specifically performed according to actual scenario requirements. The face detection process may adopt a face recognition method based on PCA, a face recognition method based on elastic graph matching, a face recognition method based on an SVM, and a face recognition method based on a deep neural network.

The face recognition method based on PCA is also a face recognition method based on KL transform, KL transform being optimal orthogonal transform for image compression. After a high-dimensional image space undergoes KL transform, a new set of orthogonal bases is obtained. An important orthogonal basis thereof is retained, and these orthogonal bases may be expanded into a low-dimensional linear space. If projections of faces in these low-dimensional linear spaces are assumed to be separable, these projections may be used as feature vectors for recognition, which is a basic idea of the feature face method. However, this method requires more training samples and takes a very long time, and is completely based on statistical characteristics of image gray scale.

The face recognition method based on elastic graph matching is to define a certain invariable distance for normal face deformation in two-dimensional space, and use an attribute topology graph to represent the face. Any vertex of the topology graph includes a feature vector to record information about the face near the vertex position. The method combines gray scale characteristics and geometric factors, allows the image to have elastic deformation during comparison, and has achieved a good effect in overcoming the influence of expression changes on recognition. In addition, a plurality of samples are not needed for training for a single person, but repeated calculation is very computationally intensive.

According to the face recognition method based on SVM, a learning machine is made to achieve a compromise in experience risk and generalization ability, thereby improving the performance of the learning machine. The support vector machine mainly resolves a two-class problem, and its basic idea is to try to transform a low-dimensional linearly inseparable problem into a high-dimensional linearly separable problem. General experimental results show that SVM has a good recognition rate, but requires a large number of training samples (300 in each class), which is often unrealistic in practical application. Moreover, the support vector machine takes a long time for training and has a complicated method for implementation. There is no unified theory on the method of selecting this function.

Therefore, in the embodiment of this application, high-level abstract features may be used for face recognition, so that face recognition is more effective, and the accuracy of face recognition is greatly improved by combining a recurrent neural network.

In specific implementation, the face obtaining unit 12 may perform image recognition processing on the target image, to obtain face feature points corresponding to the target image, and intercept or mark the face image in the target image based on the face feature points. The face obtaining unit 12 may recognize and locate the face and facial features of the user in the photo by using a face detection technology (for example, a face detection technology provided by a cross-platform computer vision library OpenCV, a new vision service platform Face++, YouTu face detection, and the like). The facial feature points may be reference points indicating facial features, for example, a facial contour, an eye contour, a nose, a lip, and the like, which may be 83 reference points or 68 reference points, and a specific number of points may be determined by developers according to requirements.

The target image includes a set of face images, which may include 0, 1, or a plurality of face images.

The position recording unit 13 is configured to respectively record current position information of each face image corresponding to each of the multiple target persons in the set of face images on a corresponding set of target images at a corresponding target moment.

It may be understood that the current position information may be coordinate information, which is two-dimensional coordinates or three-dimensional coordinates. Each face image in the set of face images respectively corresponds to a piece of current position information at the target moment.

In specific implementation, for the target face image (any face image) in the set of face images, the position recording unit 13 records the current position information of the target face image on the target image at the target moment, and records the current position information of other face images in the set of face images in the same manner.

For example, if the set of face images include three face images, a coordinate 1, a coordinate 2, and a coordinate 3 of the three face images on the target image at the target moment are recorded respectively.

The track outputting unit 14 is configured to output a set of moving tracks of the set of face images within the selected time period in chronological order, each moving track according to the current position information of a face image corresponding to a respective one of the multiple target persons within the multiple sets of target images.

It may be understood that the chronological order refers to chronological order of the selected time period.

In specific implementation, after the set of face images at the target moment is compared with the set of face images at a previous moment, coordinate information of the same face image at the two moments is outputted in sequence to form a face movement track of the same face image. However, for different face images (new face images), current position information of the new face image is recorded, and the new face image may be added to the set of face images. Then at the next moment of the target moment, through the comparison of the set of face images, the face movement track of the new face may be constructed, and a set of face movement tracks of all face images in the selected time period in the set of face images may be outputted in the same manner. The new face image is added to the set of face images, which may implement real-time update of the set of face images.

For example, for the target image in the set of face images, at a target moment 1 of the selected time period, a coordinate of the target face image on the target image is a coordinate A1, at a target moment 2 of the selected time period, the coordinate of the target face image on the target image is a coordinate A2, and at a target moment 3 of the selected time period, a coordinate of the target face image on the target image is a coordinate A3. Then A1, A2, A3 are displayed in sequence in chronological order, and preferably, A1, A2, and A3 are mapped into specific face movement tracks through video frames. For the method for outputting the moving track of other face images, reference may be made to the output process of the moving track of the target face image, and details are not described herein, thereby forming a set of moving tracks.

In some embodiments, after obtaining the set of moving tracks of the face, the moving tracks of each face in the set of moving tracks may be compared in pairs to determine the same moving track thereof. Preferably, pedestrian information indicated by the same moving track may be analyzed, and when it is determined, based on the analysis result, that an abnormal condition exists, an alarm prompt is transmitted to the corresponding pedestrian to prevent property loss or avoid potential safety hazards.

The system is mainly used for home security similar to an intelligent residential district, providing automatic security monitoring services for householders, security guards, and the like. There are three aspects in the implementation. A high-definition camera or an ordinary surveillance camera is used as front-end hardware. The camera may be installed in various corners of various scenarios. Various expansion functions are provided by major product manufacturers. The YouBox of the backend Tencent Youtu provides face recognition and sensor control. The display terminal adopts a display method on a mobile phone client.

In the embodiment of the application, by recognizing the face image in the collected video and recording the position information of the face image appearing in the video at different moments to restore the face movement track, the user is monitored based on the face movement track, avoiding variability, diversity, and instability of the human body behavior, thereby reducing the calculation amount of the user monitoring behavior. In addition, the behavior of determining a pedestrian in the monitoring scenario based on the analysis of the face movement track enriches the monitoring calculation method, and provides strong support for security in various scenarios.

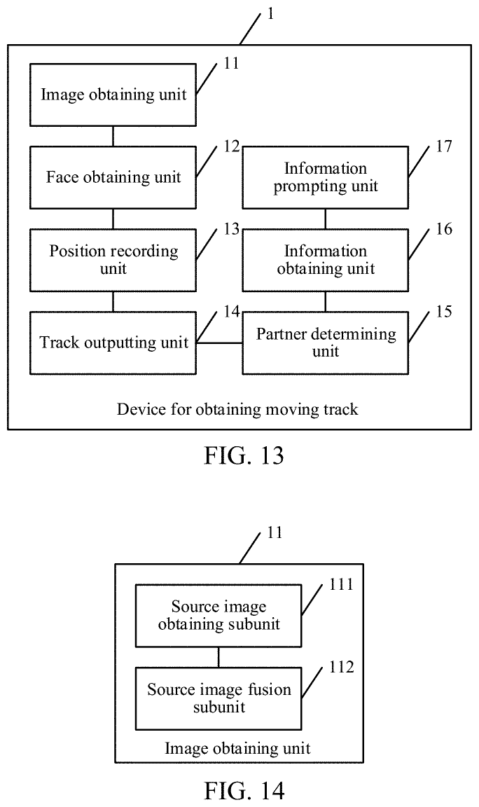

FIG. 13 is a schematic diagram of another device for obtaining a moving track according to an embodiment of this application. As shown in FIG. 13, a device 1 for obtaining a moving track in the embodiment of this application may include: an image obtaining unit 11, a face obtaining unit 12, a position recording unit 13, a track outputting unit 14, a fellow determining unit 15, an information obtaining unit 16, and an information prompting unit 17.

The image obtaining unit 11 is configured to obtain a target image generated for a photographed area at a target moment of a selected time period.

It may be understood that the selected time period may be any time period selected by a user, which may be a current time period, or may be a historical time period. Any moment within the selected time period is a target moment.

There is at least one camera in the photographed area, and when a plurality of cameras exist, fields of view among the plurality of cameras overlap. The photographed area may be a monitoring area such as a bank, a shopping mall, an independent store, and the like. The camera may be a fixed camera or a rotatable camera.

As shown in FIG. 14, the image obtaining unit 11 includes:

a source image obtaining subunit 111 configured to obtain a first source image collected by a first camera for the photographed area at the target moment of the selected time period, and obtain a second source image collected by a second camera for the photographed area at the target moment.

It may be understood that the fields of view of the first camera and the second camera overlap, that is, there are the same pixel points in the images collected by the two cameras. More same pixel points lead to a larger overlapping area of the field of view. For example, FIG. 4A shows the first source image collected by the first camera, and FIG. 4B shows the second source image collected by the second camera with the field of view overlapping that of the first camera, then the first source image and the second source image have an area that is partially the same.

Each camera collects a video stream in a selected time period, and the video stream includes a multi-frame video, that is, a multi-frame image, and a per-frame image is in a one-to-one correspondence with time.

In specific implementation, the source image obtaining subunit 111 intercepts a first video stream corresponding to the selected time period from the video stream collected by the first camera, then finds the video frame corresponding to the target moment in the first video stream, that is, the first source image, and finds the second source image corresponding to the second camera at the target moment in the same manner.

A source image fusion subunit 112 is configured to perform fusion processing on the first source image and the second source image to generate the target image.

It may be understood that the fusion processing may be an image fusion technology based on SIFT features, or may be an image fusion technology based on SURF features, and may further be an image fusion technology based on ORB features. The SIFT feature is a local feature of an image, has good invariance to translation, rotation, scale scaling, brightness change, occlusion and noise, and maintains a certain degree of stability for visual change and affine transformation. The bottleneck of time complexity in the SIFT algorithm lies in establishment and matching of a descriptor. How to optimize the description method of feature points is the key to improve SIFT efficiency. The SURF algorithm has an advantage of a faster speed than the SIFT, and has good stability. In terms of time, the running speed of SURF is about 3 times of SIFT. In terms of quality, SURF has good robustness and higher recognition rate of feature points than SIFT. SURF is generally superior to SIFT in terms of viewing angle, illumination, and scale changes. The ORB algorithm is divided into two parts, respectively feature point extraction and feature point description. Feature extraction is developed by features from a FAST algorithm, and feature point description is improved according to a BRIEF feature description algorithm. The ORB feature combines the detection method of FAST feature points with the BRIEF feature descriptor, and makes improvement and optimization on the original basis. In the embodiment of this application, the image fusion technology of the ORB feature is preferentially adopted. The ORB algorithm is 100 times faster than the SIFT algorithm and 10 times faster than the SURF algorithm. The ORB algorithm may quickly and effectively fuse images of a plurality of cameras, reduce the number of processed image frames, and improve efficiency. The image fusion technology mainly includes the process of feature extraction, image registration, and image splicing.

The source image fusion subunit 112 is specifically configured to:

extract a set of first feature points of the first source image and a set of second feature points of the second source image, respectively.

It may be understood that the feature points of the image may be simply understood as relatively significant points in the image, such as contour points, bright points in darker areas, dark points in lighter areas, and the like. The feature points in the set of feature points may include boundary feature points, contour feature points, straight line feature points, corner point feature points, and the like. However, the ORB uses the FAST algorithm to detect feature points, that is, based on the image gray values around the feature points, detects the pixel values around the candidate feature points. If there are enough pixel points in the area around the candidate point, which have gray values different from that of the candidate point, the candidate point is considered as a feature point.

The rest of the feature points on the target image may be obtained by rotating a scanning line. For the method for obtaining the rest of the feature points, reference may be made to the process of acquiring the first feature point, and details are not described herein. It may be understood that the source image fusion subunit 112 may obtain a target number of feature points, and the target data may be specifically specified according to empirical values. For example, as shown in FIG. 6, 68 feature points on the target image may be obtained. The feature points are reference points indicating facial features, such as a facial contour, an eye contour, a nose, a lip, and the like.

A matching feature point pair of the first source image and the second source image is obtained based on a similarity between each feature point in the set of first feature points and each feature point in the set of second feature points, and an image space coordinate transformation matrix is calculated based on the matching feature point pair.

It may be understood that the registration process for the two images is to find the matching feature point pair in the set of feature points of the two images through similarity measurement, and then calculate the image space coordinate transformation matrix through the matching feature point pair. In other words, the image registration process is a process of calculating an image space coordinate transformation matrix.

The image registration method may include relative registration and absolute registration. Relative registration is selecting one of a plurality of images as a reference image and registering other related images with the image, which has an arbitrary coordinate system. Absolute registration means defining a control grid first, all images being registered relative to the grid, that is, geometric correction of each component image is completed separately to realize the unification of coordinate systems.

Either one of the first source image and the second source image may be selected as a reference image, or a designated reference image may be used as a reference image, and the image space coordinate transformation matrix is calculated by using a gray information method, a transformation domain method, or a feature method.

The first source image and the second source image are spliced according to the image space coordinate transformation matrix, to generate the target image.

In specific implementation, the method for splicing the two images may be to copy one image to another image according to the image space coordinate transformation matrix, or to copy the two images to the reference image according to the image space coordinate transformation matrix, thereby implementing the splicing process of the first source image and the second source image, and using the spliced image as the target image.

For example, after the first source image corresponding to FIG. 4A and the second source image corresponding to FIG. 4B are spliced according to the calculated coordinate transformation matrix, the target image shown in FIG. 7 may be obtained.

The source image fusion subunit 112 is further configured to:

obtain an overlapping pixel point of the target image, and obtain a first pixel value of the overlapping pixel point in the first source image and a second pixel value of the overlapping pixel point in the second source image.

It may be understood that after the first source image and the second source image are spliced, the transition at the junction of the two images will not be smooth due to the light color. Therefore, the pixel values of overlapping pixel points need to be recalculated. That is, the pixel values of overlapping pixel points in the first source image and the second source image need to be obtained respectively.

The first pixel value and the second pixel value are added by using a specified weight value, to obtain an added pixel value of the overlapping pixel point in the target image.

It may be understood that the previous image is slowly transitioned to the second image through weighted fusion, that is, the pixel values of the overlapping areas of the images are added according to a certain weight value.

In other words, a pixel value of an overlapping pixel point 1 in the first source image is S11, and a pixel value in the second source image is S21. Then, after weighted calculation based on u times S11 and v times S21, a pixel value of the overlapping pixel point 1 in the target image is uS11+Vs21.

The face obtaining unit 12 is configured to perform image recognition processing on the target image to obtain a set of face images of the target image.

It may be understood that the image recognition processing may be detecting the face area of the target image, and when the face area is detected, the face image of the target image may be marked, which may be specifically performed according to actual scenario requirements.

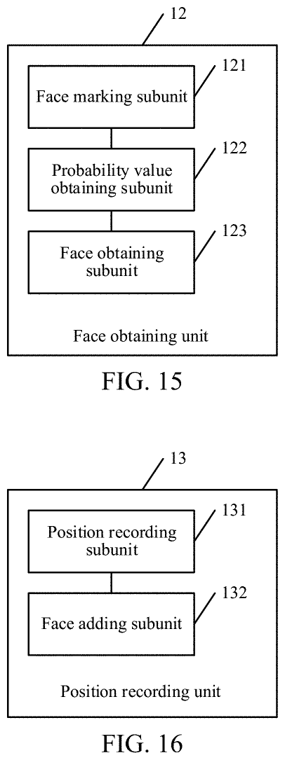

In some embodiments, as shown in FIG. 15, the face obtaining unit 12 includes:

a face marking subunit 121 configured to perform image recognition processing on the target image, and mark a set of recognized face images in the target image.

It may be understood that, the image recognition algorithm is a face recognition algorithm. The face recognition algorithm may use a face recognition method based on PCA, a face recognition method based on elastic graph matching, a face recognition method based on an SVM, and a face recognition method based on a deep neural network.

The face recognition method based on PCA is also a face recognition method based on KL transform, KL transform being optimal orthogonal transform for image compression. After a high-dimensional image space undergoes KL transform, a new set of orthogonal bases is obtained. An important orthogonal basis thereof is retained, and these orthogonal bases may be expanded into a low-dimensional linear space. If projections of faces in these low-dimensional linear spaces are assumed to be separable, these projections may be used as feature vectors for recognition, which is a basic idea of the feature face method. However, this method requires more training samples and takes a very long time, and is completely based on statistical characteristics of image gray scale.

The face recognition method based on elastic graph matching is to define a certain invariable distance for normal face deformation in two-dimensional space, and use an attribute topology graph to represent the face. Any vertex of the topology graph includes a feature vector to record information about the face near the vertex position. The method combines gray scale characteristics and geometric factors, allows the image to have elastic deformation during comparison, and has achieved a good effect in overcoming the influence of expression changes on recognition. In addition, a plurality of samples are not needed for training for a single person, but repeated calculation is very computationally intensive.

According to the face recognition method based on SVM, a learning machine is made to achieve a compromise in experience risk and generalization ability, thereby improving the performance of the learning machine. The support vector machine mainly resolves a two-class problem, and its basic idea is to try to transform a low-dimensional linearly inseparable problem into a high-dimensional linearly separable problem. General experimental results show that SVM has a good recognition rate, but requires a large number of training samples (300 in each class), which is often unrealistic in practical application. Moreover, the support vector machine takes a long time for training and has a complicated method for implementation. There is no unified theory on the method of selecting this function.

Therefore, in the embodiment of this application, high-level abstract features may be used for face recognition, so that face recognition is more effective, and the accuracy of face recognition is greatly improved by combining a recurrent neural network.

A deep neural network is a CNN. In the CNN, neurons of the convolution layer are only connected to some neuron nodes of the previous layer, that is, the connections between neurons thereof are not fully connected, and a weight ww and an offset bb of the connection between some nerves in the same layer are shared (that is, the same), which greatly reduces the number of required training parameters. A structure of the convolutional neural network CNN generally includes a multi-layer structure: an input layer configured to input data; a convolutional layer configured to extract and map features by using a convolution kernel; an excitation layer, since convolution is also a linear operation, nonlinear mapping needing to be increased; a pooling layer performing downsampling and performing thinning processing on a feature map, to reduce the amount of calculated data; a fully connected layer usually refitted at the end of the CNN to reduce the loss of feature information; and an output layer configured to output a result. Definitely, some other functional layers may also be used in the middle, for example, a normalization layer normalizing the features in the CNN; a segmentation layer learning some (picture) data separately by area; and a fusion layer fusing branches that independently perform feature learning.

That is, after the face is detected and the key feature points of the face are located, the main face area may be extracted and fed into the back-end recognition algorithm after preprocessing. The recognition algorithm is to be used for completing the extraction of face features and comparing a face with the known faces in stock, so as to determine a set of face images included in the target image. The neural network may have different depth values, such as a depth value of 1, 2, 3, 4, or the like, because features of CNNs of different depths represent different levels of abstract features. A deeper depth leads to a more abstract feature of the CNN, and the features of different depths may be used for describing the face more comprehensively, achieving a better effect of face detection.

The recognized face image is marked, it may be understood that a recognized result is marked with shapes such as rectangle, ellipse, or circle. For example, as shown in FIG. 9A, when a face image is recognized in the target image, the face image is marked by using a rectangular frame. Preferably, if there are a plurality of recognition results for the same object, each recognition result is respectively marked with a rectangular frame, as shown in FIG. 9B.

A probability value obtaining subunit 122 is configured to obtain a face probability value of a set of target face images in the set of marked face images.

It may be understood that, in the set of face images, there are a plurality of recognition results for the target face image, and each recognition result corresponds to a face probability value, the face probability value being a score of a classifier.

For example, if there are 5 face images in the set of face images, one of the face images is selected as the target image. If there are 3 recognition results for the target image, there are corresponding 3 face probability values.

A face obtaining subunit 123 is configured to determine, based on the face probability value, a target face image in the set of target face images by using a non-maximum suppression algorithm, and obtain the set of face images of the target image from the set of marked face images.

It may be understood that since there are a plurality of recognition results for the same target face image, and the plurality of recognition results overlap, it is also necessary to perform non-maximum suppression on marked face frames to delete the face frame with a relatively large degree of overlapping.

The non-maximum suppression is to suppress elements that are not maxima, and search for the local maxima. This local part represents a neighborhood. The neighborhood has two variable parameters, one is a dimension of the neighborhood, and the other is a size of the neighborhood. For example, in pedestrian detection, each sliding window will get a score after feature extraction and classification and recognition by the classifier. However, the sliding windows will cause many windows to contain or mostly intersect with other windows. In this case, non-maximum suppression is needed to select the windows with the highest scores (that is, the highest probability of face images) in the neighborhood, and suppress the windows with low scores.

For example, assuming that six rectangular frames are recognized and marked for the same target face image, sorting is performed according to the classification probability of the classifier category, and the probabilities of belonging to faces in ascending order are A, B, C, D, E, and F, respectively. From the maximum probability rectangular frame F, it is respectively determined whether the degree of overlapping IOU of A to E and F is greater than a certain specified threshold value. Assuming that the degree of overlapping of B, D, and F exceeds the threshold value, then B and D are discarded, and the first rectangular frame F is retained. From the remaining rectangular frames A, C, and E, E with the largest probability is selected, and then the overlapping degree between E and A and C is determined. If the overlapping degree is greater than a certain threshold, then A and C are discarded, and the second rectangular frame E is retained, and so on, thereby finding the optimal rectangular frame.

In specific implementation, the probability values of a plurality of faces of the same target face are sorted, the target face images with lower scores are suppressed through a non-maximum suppression algorithm to determine the optimal face images, and each target face image in the set of face images is recognized in turn in the same manner, thereby finding a set of optimal face images in the target image.

The position recording unit 13 is configured to respectively record current position information of each face image in the set of face images on the target image at the target moment.

The current position information may be coordinate information, which is two-dimensional coordinates or three-dimensional coordinates. Each face image in the set of face images respectively corresponds to a piece of current position information at the target moment.

In some embodiments, as shown in FIG. 16, the position recording unit 13 includes:

a position recording subunit 131 configured to respectively record current position information of each face image on the target image at the target moment in a case that all the face images are found in a face database.

In specific implementation, the set of recognized face images are compared with the face database to determine whether the set of face images all exist in the face database. If yes, it indicates that set of these face images have been recognized at a previous moment of the target moment, and in this case, the current position information of each face image on the target image at the target moment is recorded.

The face database is a face information database for collection and storage in advance, and may include relevant data of a face and personal information of a user corresponding to the face. Preferably, the face database is obtained through pulling toward the server by the device for obtaining a moving track.

For example, if the face images A, B, C, D, and E in the set of face images all exist in the face database, coordinates of A, B, C, D, and E on the target image at the target moment are recorded respectively.

A face adding subunit 132 is configured to add a first face image to the face database in a case that the first face image of the set of face images is not found in the face database.

In specific implementation, the set of recognized face images are compared with the face database to determine whether the set of face images all exist in the face database. If some or all of the images do not exist in the face database, it indicates that the set of these face images are not recognized at the previous moment of the target moment. In this case, the current position information of each face image on the target image at the target moment is recorded, and the position information and the face image are added to the face database. On the one hand, the real-time update of the face database may be realized, and on the other hand, all the recognized face images and the corresponding position information may be completely recorded.

For example, A in the face images A, B, C, D, and E in the set of face images does not exist in the face database, the coordinates of A, B, C, D, and E on the target image at the target moment are recorded respectively, and the image information of A and the corresponding position information are added to the face database for comparison of A at the next moment of the target moment.

The track outputting unit 14 is configured to output a set of moving tracks of the set of face images within the selected time period in chronological order based on the current position information.

In specific implementation, after the set of face images at the target moment is compared with the set of face images at a previous moment, coordinate information of the same face image at the two moments is outputted in sequence to form a face movement track of the same face image. However, for different face images (new face images), current position information of the new face image is recorded, and the new face image may be added to the set of face images. Then at the next moment of the target moment, through the comparison of the set of face images, the face movement track of the new face may be constructed, and a set of face movement tracks of all face images in the selected time period in the set of face images may be outputted in the same manner. The new face image is added to the set of face images, which may implement real-time update of the set of face images.

For example, for the target image in the set of face images, at a target moment 1 of the selected time period, a coordinate of the target face image on the target image is a coordinate A1, at a target moment 2 of the selected time period, the coordinate of the target face image on the target image is a coordinate A2, and at a target moment 3 of the selected time period, a coordinate of the target face image on the target image is a coordinate A3. Then A1, A2, A3 are displayed in sequence in chronological order, and preferably, A1, A2, and A3 are mapped into specific face movement tracks through video frames. For the method for outputting the moving track of other face images, reference may be made to the output process of the moving track of the target face image, and details are not described herein, thereby forming a set of moving tracks. The track analysis based on the face is creatively realized by using the face movement track, instead of the analysis based on a human body shape, thereby avoiding the variability and instability of the appearance of the human body shape.

The fellow determining unit 15 is configured to determine that second pedestrian information indicated by a second moving track has a fellow relationship with first pedestrian information indicated by a first moving track in a case that the second moving track in the set of moving tracks is the same as the first moving track in the set of moving tracks.

It may be understood that by comparing the movement tracks corresponding to every two face images in the set of movement tracks, when an error of the two comparison results is within a certain threshold range, the two movement tracks may be considered to be the same, and then pedestrians corresponding to the two movement tracks may be determined as fellows.

Through the analysis of the set of face movement tracks, the potential “fellow” detection is provided, so that the monitoring level is improved from conventional monitoring for individuals to monitoring for groups.

The information obtaining unit 16 is configured to obtain personal information associated with the second pedestrian information.

In a feasible implementation, when it is determined that the second pedestrian is a fellow of the first pedestrian, it is necessary to verify the legitimacy of the second pedestrian, and personal information of the second pedestrian needs to be obtained, for example, personal information of the second pedestrian is requested from the server based on the face image of the second pedestrian.

The information prompting unit 17 is configured to output, to a terminal device corresponding to the first pedestrian information in a case that the personal information does not exist in a whitelist information database, prompt information indicating that the second pedestrian information is abnormal.

It may be understood that the whitelist information database includes user information with legal rights, such as personal credit, access rights to information, no bad records, and the like.

In specific implementation, when the device for obtaining a moving track does not find the personal information of the second pedestrian in the whitelist information database, it is determined that the second pedestrian has abnormal behavior, and warning information is outputted to the first pedestrian for prompt, to prevent the loss of interest or safety from being generated. The warning information may be output in the form of text, audio, flashing lights, and the like. The specific method is not limited.

The system is mainly used for home security similar to an intelligent residential district, providing automatic security monitoring services for householders, security guards, and the like. There are three aspects in the implementation. A high-definition camera or an ordinary surveillance camera is used as front-end hardware. The camera may be installed in various corners of various scenarios. Various expansion functions are provided by major product manufacturers. The YouBox of the backend Tencent Youtu provides face recognition and sensor control. The display terminal adopts a display method on a mobile phone client.

In the embodiment of the application, by recognizing the face image in the collected video and recording the position information of the face image appearing in the video at different moments to restore the face movement track, the user is monitored based on the face movement track, avoiding variability, diversity, and instability of the human body behavior, thereby reducing the calculation amount of the user monitoring. In addition, the behavior of determining a pedestrian in the monitoring scenario based on the analysis of the face movement track enriches the monitoring calculation method, and behavior of pedestrians in the scene is monitored from point to surface, from individual to group, from monitoring to reminding, and through multi-scale analysis, which provides strong support for security in various scenarios. In addition, due to the end-to-end statistical architecture, it is very convenient in practical application and has a wider application range.

An embodiment of this application further provides a computer storage medium, the computer storage medium storing a plurality of instructions, the instructions being suitable for being loaded by a processor and performing the method steps of the embodiment shown in FIG. 1A to FIG. 11 above. For the specific execution process, reference may be made to the specific descriptions of the embodiments shown in FIG. 1A to FIG. 11, and details are not described herein again.

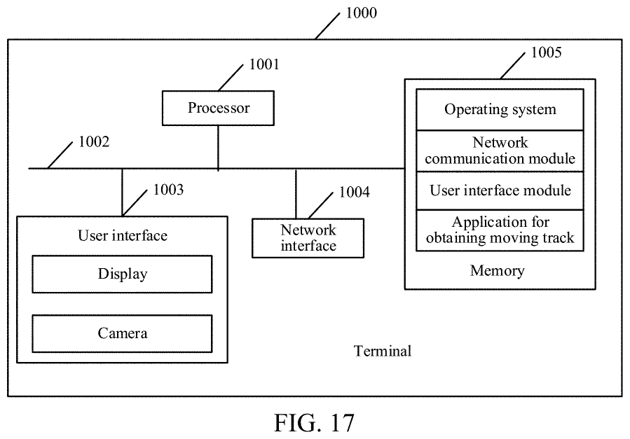

FIG. 17 is a schematic structural diagram of a terminal according to an embodiment of this application. As shown in FIG. 17, a terminal 1000 may include: at least one processor 1001, such as a CPU, at least one network interface 1004, a user interface 1003, a memory 1005, and at least one communication bus 1002. The communication bus 1002 is configured to implement connection communication between these components. The user interface 1003 may include a display and a camera, and the optional user interface 1003 may further include a standard wired interface and a wireless interface. In some embodiments, the network interface 1004 may include a standard wired interface and a wireless interface (such as a WI-FI interface). The memory 1005 may be a high-speed RAM memory or a non-volatile memory, such as at least one magnetic disk memory. In some embodiments, the memory 1005 may further be at least one storage device away from the foregoing processor 1001. As shown in FIG. 17, as a computer storage medium, the memory 1005 may include an operating system, a network communication module, a user interface module, and an application for obtaining a moving track.

In the terminal 1000 shown in FIG. 17, the user interface 1003 is mainly used for providing an input interface for a user to obtain data input by the user. The processor 1001 may be used for calling the application for obtaining a moving track stored in the memory 1005, and specifically perform the following operations:

obtaining multiple sets of target images generated by multiple cameras for a photographed area, each set of target images being captured at a respective target moment within a selected time period;

performing image recognition on each of the multiple sets of target images to obtain a set of face images of multiple target persons in the set of target images;

respectively recording current position information of each face image corresponding to each of the multiple target persons in the set of face images on a corresponding set of target images at a corresponding target moment; and

outputting a set of moving tracks of the set of face images within the selected time period in chronological order, each moving track according to the current position information of a face image corresponding to a respective one of the multiple target persons within the multiple sets of target images.

In an embodiment, when obtaining multiple sets of target images generated by multiple cameras for a photographed area, each set of target images being captured at a respective target moment within a selected time period, the processor 1001 specifically performs the following operations:

obtaining a first source image collected by a first camera for the photographed area at the target moment of the selected time period, and obtaining a second source image collected by a second camera for the photographed area at the target moment; and

performing fusion processing on the first source image and the second source image to generate the target image.

In an embodiment, when performing fusion processing on the first source image and the second source image to generate the target image, the processor 1001 specifically performs the following operations:

extracting a set of first feature points of the first source image and a set of second feature points of the second source image, respectively;

obtaining a matching feature point pair of the first source image and the second source image based on a similarity between each feature point in the set of first feature points and each feature point in the set of second feature points, and calculating an image space coordinate transformation matrix based on the matching feature point pair; and

splicing the first source image and the second source image according to the image space coordinate transformation matrix, to generate the target image.

In an embodiment, after splicing the first source image and the second source image according to the image space coordinate transformation matrix, to generate the target image, the processor 1001 further performs the following operations:

obtaining an overlapping pixel point of the target image, and obtaining a first pixel value of the overlapping pixel point in the first source image and a second pixel value of the overlapping pixel point in the second source image; and

adding the first pixel value and the second pixel value by using a specified weight value, to obtain an added pixel value of the overlapping pixel point in the target image.

In an embodiment, when the performing image recognition on each of the multiple sets of target images to obtain a set of face images of the multiple target persons in the set of target images, the processor 1001 specifically performs the following operations:

performing image recognition processing on the target image, and marking a set of recognized face images in the target image;

obtaining a face probability value of a set of target face images in the set of marked face images; and

determining a target face image in the set of target face images based on the face probability value, and determining the set of face images of the target image in the set of marked face images.

In an embodiment, when respectively recording the current position information of each face image in the set of face images on the target image at the target moment, the processor 1001 specifically performs the following operations:

respectively recording current position information of each face image on the target image at the target moment in a case that all the face images are found in a face database; and

adding a first face image to the face database in a case that the first face image of the set of face images is not found in the face database.

In an embodiment, the processor 1001 further performs the following operation:

selecting, among the set of moving tracks, a first moving track and a second moving track that is substantially the same as the first moving track;

obtaining personal information of a first target person corresponding to the first moving track and a second target person corresponding to the second moving track; and

marking the personal information indicating that the first target person and the second target person are travel companions of each other

In an embodiment, after marking the personal information indicating that the first target person and the second target person are travel companions of each other, the processor 1001 further performs the following operations:

obtaining personal information associated with the second pedestrian information; and

outputting, to a terminal device corresponding to the first pedestrian information in a case that the personal information does not exist in a whitelist information database, prompt information indicating that the second pedestrian information is abnormal.

In the embodiment of the application, by recognizing the face image in the collected video and recording the position information of the face image appearing in the video at different moments to restore the face movement track, the user is monitored based on the face movement track, avoiding variability, diversity, and instability of the human body behavior, thereby reducing the calculation amount of the user monitoring. In addition, the behavior of determining a pedestrian in the monitoring scenario based on the analysis of the face movement track enriches the monitoring calculation method, and behavior of pedestrians in the scene is monitored from point to surface, from individual to group, from monitoring to reminding, and through multi-scale analysis, which provides strong support for security in various scenarios. In addition, due to the end-to-end statistical architecture, it is very convenient in practical application and has a wider application range.

A person skilled in this field can understand that, all or some procedures in the methods in the foregoing embodiments may be implemented by a program instructing related hardware. The program may be stored in a computer readable storage medium. When being executed, the program may include the procedures according to the embodiments of the foregoing methods. The storage medium may be a magnetic disk, an optical disc, a read-only memory (ROM), a random access memory (RAM), or the like.

The foregoing disclosure is merely exemplary embodiments of this application, and certainly is not intended to limit the protection scope of this application. Therefore, equivalent variations made in accordance with the claims of this application shall fall within the scope of this application.

What is claimed is:

1. A method for obtaining moving tracks of multiple target persons, performed by a computing device having a processor and memory storing a plurality of computer programs to be executed by the processor, the method comprising:
obtaining multiple sets of target images generated by multiple cameras for a photographed area, each set of target images being captured at a respective target moment within a selected time period;
performing image recognition on each of the multiple sets of target images to obtain a set of face images of the multiple target persons in the set of target images;
respectively recording current position information of each face image corresponding to each of the multiple target persons in the set of face images on a corresponding set of target images at a corresponding target moment; and
outputting a set of moving tracks of the set of face images within the selected time period in chronological order, each moving track according to the current position information of a face image corresponding to a respective one of the multiple target persons within the multiple sets of target images.

2. The method according to claim 1, wherein the obtaining multiple sets of target images generated by multiple cameras for a photographed area, each set of target images being captured at a respective target moment within a selected time period comprises:
obtaining a first source image collected by a first camera for the photographed area at the target moment of the selected time period;
obtaining a second source image collected by a second camera for the photographed area at the target moment; and
performing fusion processing on the first source image and the second source image to generate the target image.

3. The method according to claim 2, wherein the performing fusion processing on the first source image and the second source image to generate the target image comprises:
extracting a set of first feature points of the first source image and a set of second feature points of the second source image, respectively;
obtaining a matching feature point pair of the first source image and the second source image based on a similarity between each feature point in the set of first feature points and each feature point in the set of second feature points, and calculating an image space coordinate transformation matrix based on the matching feature point pair; and
splicing the first source image and the second source image according to the image space coordinate transformation matrix, to generate the target image.

4. The method according to claim 3, wherein after the splicing the first source image and the second source image according to the image space coordinate transformation matrix, to generate the target image, the method further comprises:
obtaining an overlapping pixel point of the target image, and obtaining a first pixel value of the overlapping pixel point in the first source image and a second pixel value of the overlapping pixel point in the second source image, the overlapping pixel point being formed by splicing the first source image and the second source image; and
adding the first pixel value and the second pixel value by using a specified weight value, to obtain an added pixel value of the overlapping pixel point in the target image.

5. The method according to claim 1, wherein the performing image recognition on each of the multiple sets of target images to obtain a set of face images of the multiple target persons in the set of target images comprises:
performing image recognition on one of the multiple sets of target images, and marking a set of recognized face images in the set of target images;
obtaining a face probability value of a set of target face images in the set of marked face images; and
determining a target face image in the set of target face images based on the face probability value, and determining the set of face images of the target image in the set of marked face images.

6. The method according to claim 5, wherein the respectively recording current position information of each face image in the set of face images on the target image at the target moment comprises:
respectively recording current position information of each face image on the target image at the target moment in a case that all the face images are found in a face database; and
adding a first face image to the face database in a case that the first face image of the set of face images is not found in the face database.

7. The method according to claim 1, further comprising:
selecting, among the set of moving tracks, a first moving track and a second moving track that is substantially the same as the first moving track;
obtaining personal information of a first target person corresponding to the first moving track and a second target person corresponding to the second moving track; and
marking the personal information indicating that the first target person and the second target person are travel companions of each other.

8. The method according to claim 7, wherein after the marking the personal information indicating that the first target person and the second target person are travel companions of each other, the method further comprises:
sending, to a terminal device corresponding to the first target person in a case that the personal information of the second target person does not exist in a whitelist information database associated with the first target person.

9. A computing device, comprising: a processor and a memory; the memory storing a plurality of computer programs, the computer programs being adapted to be executed by the processor to perform a plurality of operations including:
obtaining multiple sets of target images generated by multiple cameras for a photographed area, each set of target images being captured at a respective target moment within a selected time period;
performing image recognition on each of the multiple sets of target images to obtain a set of face images of multiple target persons in the set of target images;
respectively recording current position information of each face image corresponding to each of the multiple target persons in the set of face images on a corresponding set of target images at a corresponding target moment; and
outputting a set of moving tracks of the set of face images within the selected time period in chronological order, each moving track according to the current position information of a face image corresponding to a respective one of the multiple target persons within the multiple sets of target images.

10. The computing device according to claim 9, wherein the obtaining multiple sets of target images generated by multiple cameras for a photographed area, each set of target images being captured at a respective target moment within a selected time period comprises:
obtaining a first source image collected by a first camera for the photographed area at the target moment of the selected time period;
obtaining a second source image collected by a second camera for the photographed area at the target moment; and
performing fusion processing on the first source image and the second source image to generate the target image.

11. The computing device according to claim 10, wherein the performing fusion processing on the first source image and the second source image to generate the target image comprises:
extracting a set of first feature points of the first source image and a set of second feature points of the second source image, respectively;
obtaining a matching feature point pair of the first source image and the second source image based on a similarity between each feature point in the set of first feature points and each feature point in the set of second feature points, and calculating an image space coordinate transformation matrix based on the matching feature point pair; and
splicing the first source image and the second source image according to the image space coordinate transformation matrix, to generate the target image.

12. The computing device according to claim 11, wherein the plurality of operations further comprise:
after splicing the first source image and the second source image according to the image space coordinate transformation matrix:
obtaining an overlapping pixel point of the target image, and obtaining a first pixel value of the overlapping pixel point in the first source image and a second pixel value of the overlapping pixel point in the second source image, the overlapping pixel point being formed by splicing the first source image and the second source image; and
adding the first pixel value and the second pixel value by using a specified weight value, to obtain an added pixel value of the overlapping pixel point in the target image.

13. The computing device according to claim 9, wherein the performing image recognition on each of the multiple sets of target images to obtain a set of face images of the multiple target persons in the set of target images comprises:
performing image recognition on one of the multiple sets of target images, and marking a set of recognized face images in the set of target images;
obtaining a face probability value of a set of target face images in the set of marked face images; and
determining a target face image in the set of target face images based on the face probability value, and determining the set of face images of the target image in the set of marked face images.

14. The computing device according to claim 13, wherein the respectively recording current position information of each face image in the set of face images on the target image at the target moment comprises:
respectively recording current position information of each face image on the target image at the target moment in a case that all the face images are found in a face database; and
adding a first face image to the face database in a case that the first face image of the set of face images is not found in the face database.

15. The computing device according to claim 9, wherein the plurality of operations further comprise:
selecting, among the set of moving tracks, a first moving track and a second moving track that is substantially the same as the first moving track;
obtaining personal information of a first target person corresponding to the first moving track and a second target person corresponding to the second moving track; and
marking the personal information indicating that the first target person and the second target person are travel companions of each other.

16. The computing device according to claim 15, wherein the plurality of operations further comprise:
after marking the personal information indicating that the first target person and the second target person are travel companions of each other, sending, to a terminal device corresponding to the first target person in a case that the personal information of the second target person does not exist in a whitelist information database associated with the first target person.

17. A non-transitory computer-readable storage medium storing a plurality of computer-executable instructions, the instructions, when executed by a processor of a computing device, cause the computing device to perform a plurality of operations including:
obtaining multiple sets of target images generated by multiple cameras for a photographed area, each set of target images being captured at a respective target moment within a selected time period;
performing image recognition on each of the multiple sets of target images to obtain a set of face images of multiple target persons in the set of target images;
respectively recording current position information of each face image corresponding to each of the multiple target persons in the set of face images on a corresponding set of target images at a corresponding target moment; and
outputting a set of moving tracks of the set of face images within the selected time period in chronological order, each moving track according to the current position information of a face image corresponding to a respective one of the multiple target persons within the multiple sets of target images.

18. The non-transitory computer-readable storage medium according to claim 17, wherein the obtaining multiple sets of target images generated by multiple cameras for a photographed area, each set of target images being captured at a respective target moment within a selected time period comprises:
obtaining a first source image collected by a first camera for the photographed area at the target moment of the selected time period;
obtaining a second source image collected by a second camera for the photographed area at the target moment; and
performing fusion processing on the first source image and the second source image to generate the target image.

19. The non-transitory computer-readable storage medium according to claim 17, wherein the performing image recognition on each of the multiple sets of target images to obtain a set of face images of the multiple target persons in the set of target images comprises:
performing image recognition on one of the multiple sets of target images, and marking a set of recognized face images in the set of target images;
obtaining a face probability value of a set of target face images in the set of marked face images; and
determining a target face image in the set of target face images based on the face probability value, and determining the set of face images of the target image in the set of marked face images.

20. The non-transitory computer-readable storage medium according to claim 17, wherein the plurality of operations further comprise:
selecting, among the set of moving tracks, a first moving track and a second moving track that is substantially the same as the first moving track;
obtaining personal information of a first target person corresponding to the first moving track and a second target person corresponding to the second moving track; and
marking the personal information indicating that the first target person and the second target person are travel companions of each other.
